(19) United States
(12) Patent Application Publication
(10) Pub. No.: US 2024/0424941 A1
(43) Pub. Date: Dec. 26, 2024

(54) WIRELESS DYNAMIC LOAD MANAGEMENT FOR ELECTRIC VEHICLE CHARGING STATIONS

(71) Applicant: Loop Global Inc., El Segundo, CA (US)

(72) Inventors: Dustin Cavanaugh, Marina Del Rey, CA (US); Son Lam Dang, Hawthorne, CA (US)

(21) Appl. No.: 18/340,703

(22) Filed: Jun. 23, 2023

(51) Int. Cl. B60L 53/68; B60L 53/63

(52) U.S. Cl. CPC B60L 53/68; B60L 53/63

(57) ABSTRACT

Systems and techniques are provided for wireless dynamic load management for electric vehicle (EV) charging stations. An example process includes receiving load usage data indicative of electric power consumed by EV charging station(s) on a site. Each of the EV charging station(s) may be simultaneously charging a respective EV. The example process includes determining a total electric power that has been consumed by an entire set of EV charging station(s) on the site based on the load usage data, comparing the total electric power that has been consumed by the entire set of EV charging station(s) on the site and a power threshold for the site, and based on the comparison of the total electric power that has been consumed by the entire set of EV charging station(s) and the power threshold, transmitting, to the EV charging station(s), a signal to control the electric power consumed by the EV charging station(s).

### BACKGROUND

### 1. Technical Field

The present disclosure generally relates to load management for electric vehicle charging stations. For example, aspects of the present disclosure relate to wireless dynamic load management for electric vehicle charging stations.

### 2. Introduction

Electric vehicles (EV), including but not limited to electric battery-powered vehicles, and battery-powered hybrid vehicles, include charge storage devices (e.g., batteries) that must be periodically recharged. EVs are sometimes charged using a standard home outlet (e.g., a 120-volt outlet). However, it may take several hours (e.g., eight or more hours) to completely charge an EV using a standard home outlet. As EV usage continues to increase, specialized charging setups or charging stations are becoming more common. Such stations can be used to charge EVs at a much faster rate than conventional 120-volt outlets. A charging station, sometimes referred to as Electric Vehicle Supply Equipment (EVSE), is typically hardwired directly to power lines that supply power to the charging site. Typically, an EVSE device consists of a dispenser that connects to the EV via a charging cable, and power conversion electronics that are housed in the dispenser and/or a separate cabinet or housing. Dispensers may be in designated charging locations (e.g., similar to locations of gas stations), such as adjacent to parking spaces (e.g., public parking spaces and/or private parking spaces), etc.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail using the accompanying drawings in which:

FIG. 1 illustrates an example electric vehicle (EV) charging system, including an Electric Vehicle Supply Equipment (EVSE), according to some examples of the present disclosure;

FIG. 2 illustrates an example dynamic load management system for EVSE, according to some examples of the present disclosure;

FIG. 3 illustrates an example power consumption graph of a group of EVSE, according to some examples of the present disclosure;

FIG. 4 illustrates an example wireless dynamic load management system, according to some examples of the present disclosure;

FIGS. 5A and 5B illustrate an example connection between an electrical panel, a power meter, and an EVSE, according to some examples of the present disclosure;

FIG. 6 is a flowchart illustrating an example process for dynamically managing electric power for EV charging stations, according to some examples of the present disclosure;

FIG. 7 illustrates an example of a deep learning neural network, according to some aspects of the disclosed technology; and

FIG. 8 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

An EVSE (also often referred to as a charging station, a charge point, or EV charging station) is a device that supplies electric power to charge EVs (e.g., electric cars, electric trucks, electric buses, or any electric battery-powered or gasoline/electric battery-powered vehicles). As EVs become more popular and prevalent, EVSEs have increasingly gained popularity at various locations. An electric grid (also known as a power grid) is a network of power providers and consumers that are connected by electrical transmission and distribution lines and operated by one or more control centers. A plurality of EVSEs can be part of the same grid and receives power from the same energy source/utility.

The amount of power needed to support EVSE is significant and at times requires an extensive financial investment to perform a utility service upgrade. Some electrical engineers follow the national electric code (NEC) to perform load calculations based on historical peak power demand, for example, by observing electricity usage data in a certain time interval to determine the existing load peak power demand and redistribute the available capacity for a new load to be added. However, the available electrical capacity throughout the day at a particular location varies depending on the fluctuating power demand. As such, looking at the peak power can only provide a static understanding of available electrical power.

Also, when multiple EVs are charging simultaneously at a location (e.g., within the same grid), there is a risk of overloading the location's power capacity. Therefore, there is a need for improvements in a load management system that can distribute and balance the available power dynamically in real time between EVSEs so that the grid is not overloaded and the power consumption can be optimized.

Systems, apparatuses, processes (also referred to as methods), and computer-readable media (collectively referred to as “systems and techniques” or “system”) are described herein for optimizing the dynamic load management for one or more EVSEs in real time. For example, the systems and techniques described herein can optimize the available electrical capacity at a particular location in real time by automatically and wirelessly controlling the collective electric power consumed by the EVSEs. The systems and techniques can allow electrical loads to operate at full power and curtail power demand when the site's electrical capacity is measured to be near its limit. As follows, the risk of overloading when multiple EVSEs are being used simultaneously can be prevented. Also, each EV at multiple EVSEs can be charged efficiently without having to increase the power capacity at the site.

In some examples, the dynamic load management system of the present disclosure may dynamically adapt to varying parameters associated with EVSEs at the site and/or EVs that are charging simultaneously. For example, the dynamic load management system can predict a charging pattern (e.g., maximum demand, time of demand) based on one or more characteristics of each individual EVSE, EV(s) that are connected to EVSE, and/or historical charging data. In some examples, a machine learning model can provide a probabilistic analysis of historical data and model predictions based on varying parameters associated with EVSEs and EVs. As follows, the dynamic load management system of the present disclosure may optimize the power demand and supply based on EVSEs that are currently in use or predicted to be used.

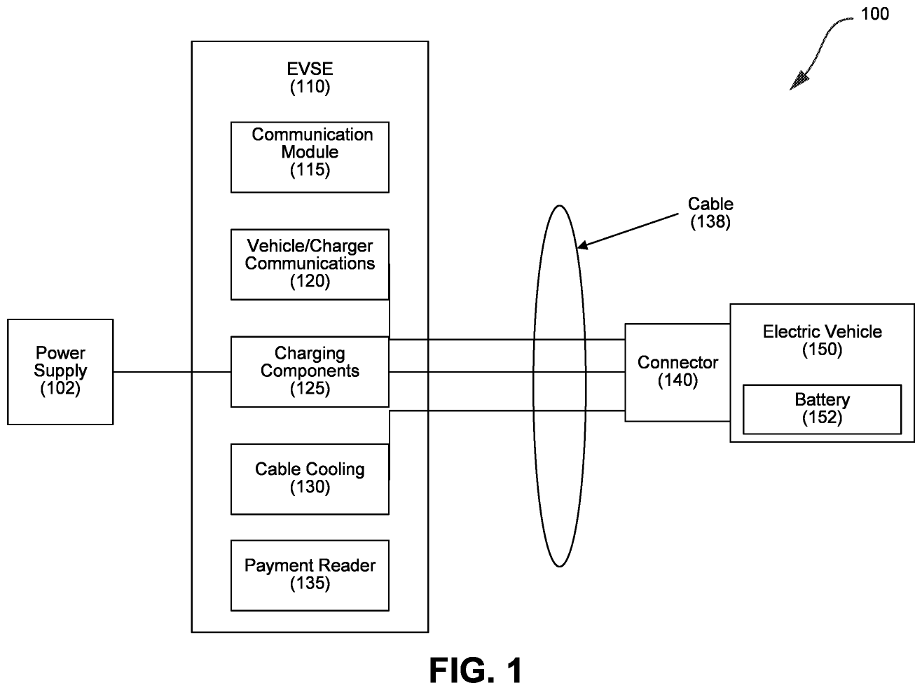

Various examples of the systems and techniques of the present disclosure described herein for dynamically managing load for EVSE are illustrated in FIG. 1 through FIG. 8 and described below.

FIG. 1 illustrates an example electric vehicle (EV) charging system 100 that includes an electric vehicle supply equipment (EVSE) 110. System 100 is configured to deliver power from an AC source (e.g., AC power supply 102), to EV 150 via EVSE 110. For example, EVSE 110 can connect to EV 150 through connector 140 of cable 138. EV 150 can be virtually any vehicle that includes a rechargeable battery 152 that powers vehicle propulsion. For example, EV 150 may be an all-EV that uses one or more electric motors powered from the battery system. Alternatively, EV 150 may be a hybrid vehicle that can use a combustion engine and one or more electric motors for propulsion. By way of example, EV 150 may include an automobile, a truck, a bus, a train, an aircraft, a ship, or a tank, or the like. Additionally, battery 152 can include one or more charge storage cells, such an array of batteries, without departing from the scope of the disclosed technology.

In operation, EVSE 110 supplies power to battery 152 through cable 138. Power management is performed by EVSE 110 using charging components 125 that manage charging of battery 152. Charging components 125 can include switches/relays, meter(s), and other electronics for managing charging of EVs. By way of example, charging components 125 may be configured to deliver direct current (DC) power or alternating current (AC) power to EV 150, depending on the desired implementation. Charging components 125 may also include multiple power connections to charge multiple batteries of EV 150 simultaneously and/or at different current rates and/or voltages.

To initiate a charging session, EVSE 110 includes vehicle/charger communications 120 that allows the EVSE 110 to communicate charging parameters and status with EV 150. For instance, vehicle/charger communications 120 may handle communication according to the J1772 standard, the CHAdeMO standard, and/or other communication standards. In some instances, payment for charging services may be initiated using a user or vehicle identifier that is received by vehicle/charger communications 120 from EV 150. In other approaches, payment information for vehicle charging may be received from the user, for example, via a user device (not illustrated), such as a wireless device (or smartphone) that is configured to communicate directly with EVSE 110, via communication module 115, or by receiving payment information directly from a payment card (such as a credit card), via payment reader 135.

Irrespective of how payment information is received by EVSE 110, payment settlement can be facilitated by communication module 115. In such approaches, the user or vehicle identifier (or other payment processing information) can be communicated by EVSE 110 to one or more third-party servers or systems, via communication module 115, to settle the transaction.

In some examples, the communication module 115 may be used to exchange data of EV 150 that is not necessarily related to managing charging. For instance, EV 150 may send navigation information such as maps, flight plans, etc. The communication module 115 may act as a pass-through to a server. The communication module 115 may be an Ethernet connection made through the connector 140.

In some aspects, cable 138 may be temperature controlled, such as to lower the cable temperature using an active cooling system, such as cable cooling 130 for cooling cable 138. The cable cooling 130 may include a liquid to air heat exchanger. The liquid in the liquid cooled cable may be an antifreeze or a combination of an antifreeze and water. The liquid in the cooled cable can also be configured to cool the connector contacts of the connector 140, etc.

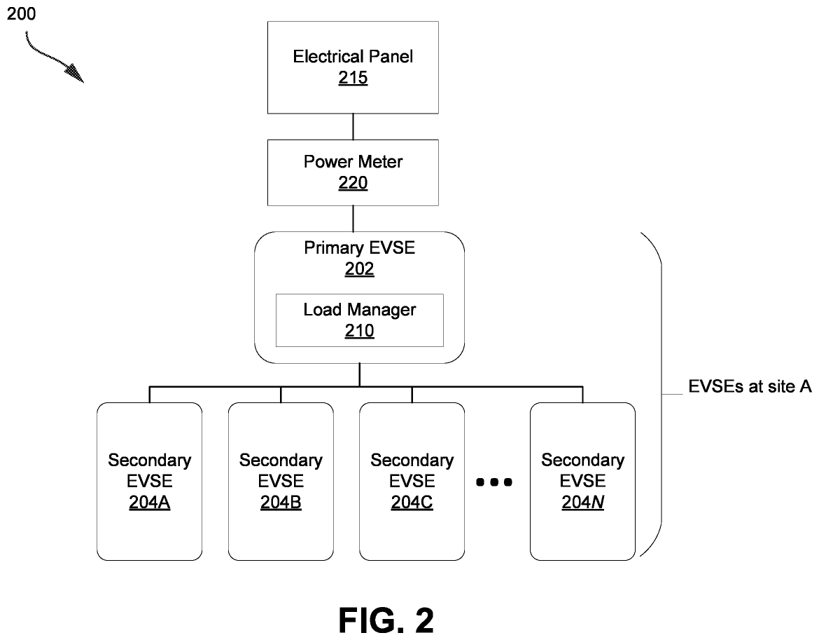

FIG. 2 illustrates an example dynamic load management system 200 for EVSE. In the illustrative example of FIG. 2, dynamic load management system 200 includes an electrical panel 215 (also known as a distribution panel or breaker panel), which is configured to receive electricity from a main power supply and distribute the electricity to various circuits and loads within a given site (e.g., site A). In some aspects, dynamic load management system 200 includes a power meter 220, which is configured to measure real-time electrical power demand. For example, power meter 220 may measure and record, via a current transformer (not shown), the power consumption of loads that are connected (e.g., the amount of current flowing) in real time. In the illustrative example of FIG. 2, power meter 220 may measure the amount of electrical energy consumed by one or more EVSEs (e.g., primary EVSE 202 and secondary EVSEs 204A-204N) on a given power grid (e.g., site A). In some cases, power meter 220 can be a detachable device that may be installed at residential, commercial, or industrial locations. For example, a detachable power meter 220 can be connected to load manager 210 via current transformer(s).

In some examples, power meter 220 can provide the information associated with the collective energy/electricity draw or collective load usage of the entire site (e.g., site A) and signal power control measure to load manager 210. For example, analog power signals that are measured from power meter 220 can be transcribed to digital data, which can be communicated to load manager 210.

In some approaches, one of the EVSEs on a given site can be designated as a primary unit with a load manager 210 and the rest of the EVSEs on the given site can be set as secondary EVSEs. For example, in the example of dynamic load management system 200, primary EVSE 202 can be selected as load manager 210 for site A. As previously described, each EVSE (e.g., primary EVSE 202, secondary EVSEs 204A-204N) has a power supply (e.g., power supply 102 as illustrated in FIG. 1) and a power interface that connects the power supply to an EV (e.g., EV 150) for charging. While multiple secondary EVSEs 204A-204N are described with respect to FIG. 2, a single EVSE or any applicable number of EVSEs can be connected at site A.

In some examples, load manager 210 at primary EVSE 202 may dynamically manage and/or control the site-level load on a power grid (e.g., site A) that comprises EVSE 204A-204N. As previously described, power meter 220 can directly communicate with load manager 210 regarding information associated with the site-level power that is received from a main power supply (e.g., power utility/facility for site A). In some examples, load manager 210 at primary EVSE 202 can manage power demand and supply at site A comprising secondary EVSEs 204A-204N. For example, load manager 210 may dynamically manage power demand and supply at one or more EVSEs 204A-204N in real time. In some approaches, load manager 210 may manage the collective power demand not to exceed a predetermined power threshold. For example, if the collective power from all loads (e.g., EVSEs 204A-204N) is measured to exceed a predetermined power threshold or near its limit (e.g., 95% of the maximum power capacity at site A), load manager 210 may send a signal to a group of connected charging stations (e.g., EVSEs 204A-204N) to gradually curtail power in a pre-determined increment (e.g., 1 amp). In some aspects, this can be achieved automatically through an application in real time (e.g., a software embedded within load manager 210) that works with or without an internet connection.

In some aspects, load manager 210 can communicate wirelessly with EVSEs 204A-204N via a wireless connection (e.g., Wi-Fi, Bluetooth low energy (BLE), etc.). For example, the site-metered electrical data from power meter 220 can be communicated to load manager 210 via an ethernet or Wi-Fi connection to create a local area network (LAN). The Wi-Fi LAN connection may allow EVSEs 204A-204N to be located farther apart from each other in a large horizontal space or among different building floors without the need to install extensive data cables between devices.

In some cases, power meter 220 may be mounted within a main service panel board (e.g., electrical panel 215) and attached with one or more transformers (CTs) around power conductors (e.g., L1/L2/L3 for 3-phase, L1/L2 for split phase, etc.) to connect power meter 220 to communicate with an EVSE (e.g., primary EVSE 202). As previously described, in some aspects, power meter 220 can be a detachable device. The communication between power meter 220 and the EVSE (e.g., primary EVSE 202) can be done via accessing a built-in web portal of power meter 220 to program the wireless connection (e.g., Wi-Fi connection) to a cellular router. In some examples, an EVSE can be connected to the same cellular router so that power meter 220 and the EVSE may share the same local Wi-Fi domain. As follows, the EVSE may be configured within it's built-in web portal to turn on/activate a dynamic load management feature.

In some examples, load manager 210 can predict a maximum power demand, time of power demand, or a power consumption pattern based on historical charging data and/or various parameters associated with one or more characteristics of individual EVSE 204A-204N (e.g., age, cable condition, etc.), one or more characteristics of individual EV (e.g., EV 150) that is connected at each EVSE 204A-204N, and/or user preferences. For example, load manager 210 may predict when a charging event will occur with a specific EV or at a particular EVSE. For example, load manager 210 may predict the date/time of power demand, the period of time for charging, the amount of energy needed for charging and determine the optimized distribution of the available power capacity. In some cases, based on the predictions of a maximum power demand, time of power demand, or a power consumption pattern, load manager 210 can schedule the power supply for forthcoming charging sessions and whether to use the default or curtailed amount of energy.

In some examples, when an EV (e.g., EV 150) accesses one of EVSE 204A-204N at site A, load manager 210 may detect one or more characteristics of the EV in real time and control the power to be delivered accordingly.

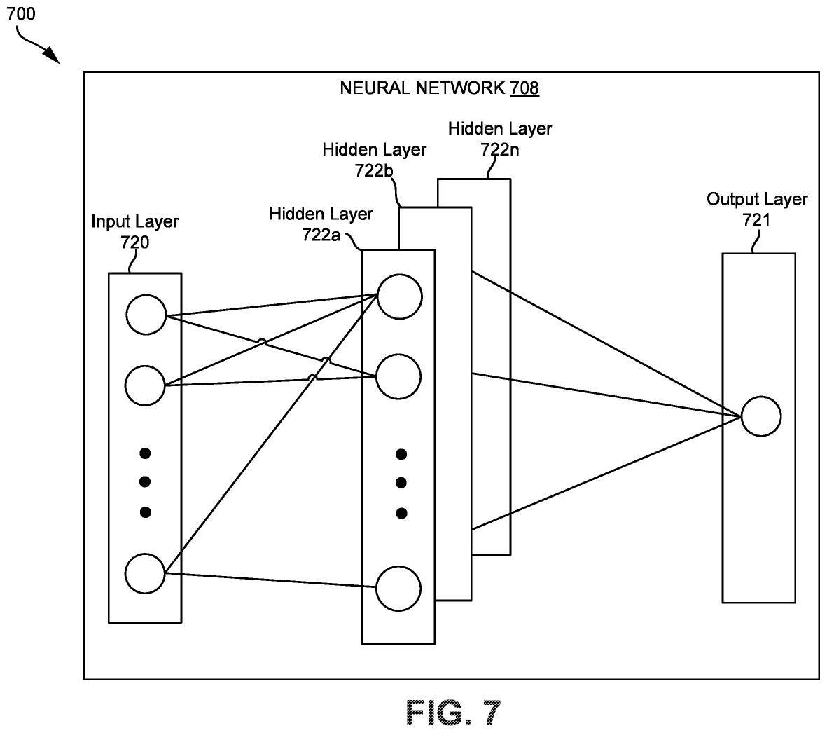

In some approaches, such predictions of maximum power demand, time of power demand, or a power consumption pattern can be obtained by a machine learning model. For example, load manager 210 may implement a machine-learning algorithm, which is configured to predict a power consumption/charging pattern as described above based on historical charging data and/or various parameters associated with EVSE and EVs that may affect the charging behavior. Further details of the implementation of a machine learning algorithm are provided below with respect to FIG. 7.

In some aspects, load manager 210 may group one or more EVSEs among EVSE 204A-204N and set a different power consumption threshold per group. In other words, load manager 210 may set a power consumption threshold for a selected group of EVSEs so that the load can be managed and controlled per group based on the maximum load threshold set for the respective group.

In some cases, dynamic load management system 200 can provide bi-directional power support (e.g., dynamic load management system 200 to receive and supply power in both directions), which may allow the flow of electrical energy in both directions, enabling energy transfer between different sources or loads. For example, dynamic load management system 200 can allow the flow of electricity not only from a power grid (e.g., power from utility 430) to loads but also from distributed energy resources back to the power grid. As follows, EV(s) that are equipped with the bi-directional power support capabilities may, via dynamic load management system 200, supply power back to a power grid or other loads.

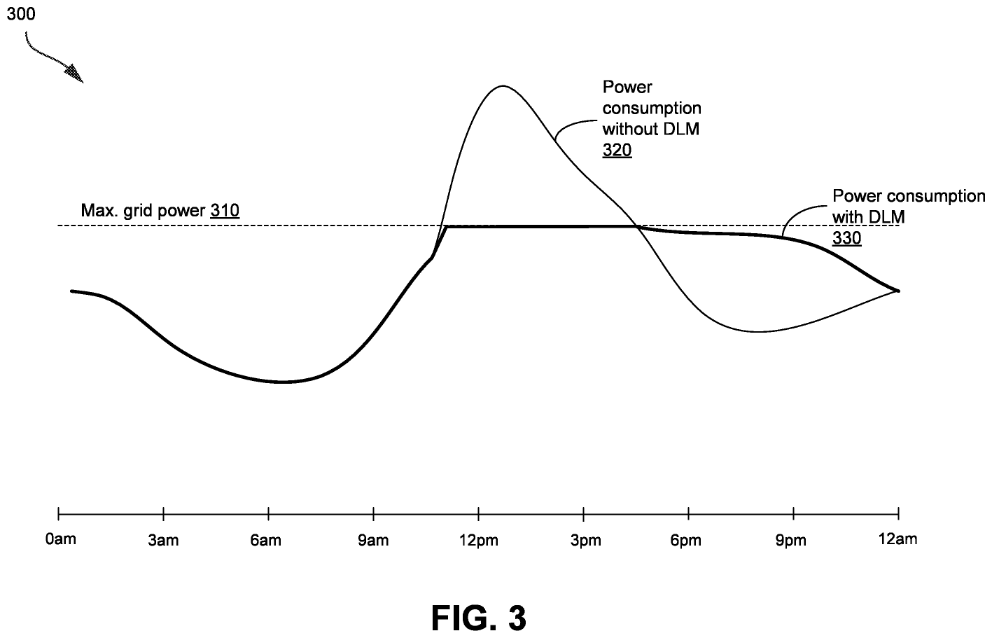

FIG. 3 illustrates an example 24-hour power capacity graph 300. As shown, a maximum grid power 310 at a given site is indicated by a dotted line, line 320 indicates power consumption without dynamic load management, and line 330 indicates power consumption with dynamic load management (e.g., dynamic load management system 200 as illustrated in FIG. 2). During peak hours between 11 am and 5 μm, the power consumption at the site exceeds the maximum power capacity when dynamic load management is not used and may result in overload or circuit break.

In some examples, the dynamic load management system of the present disclosure (e.g., load manager 210 as illustrated in FIG. 2) can detect that the total electric power consumed at the site is approaching the maximum grid power 310 or is at a pre-determined threshold (e.g., 95% of the maximum grid power 310) around at 11 am. In response to determining that the total electric power consumption is near the maximum grid power 310, the dynamic load management system (e.g., load manager 210 as illustrated in FIG. 2) can transmit a signal to control the electric power consumed by one or more EVSEs. For example, the electric power that is delivered to EVSEs can be curtailed by reducing the current by a predetermined increment (e.g., 1 amp).

In some aspects, the dynamic load management system of the present disclosure (e.g., load manager 210 as illustrated in FIG. 2) can predict that the total electric power consumption would reach the maximum grid power 310 based on one or more parameters associated with EVSEs or EVs and/or historical charging data. As follows, the dynamic load management systems (e.g., load manager 210 as illustrated in FIG. 2) can schedule a gradual reduction of the electric power or the current to preemptively avoid exceeding the maximum grid power 310.

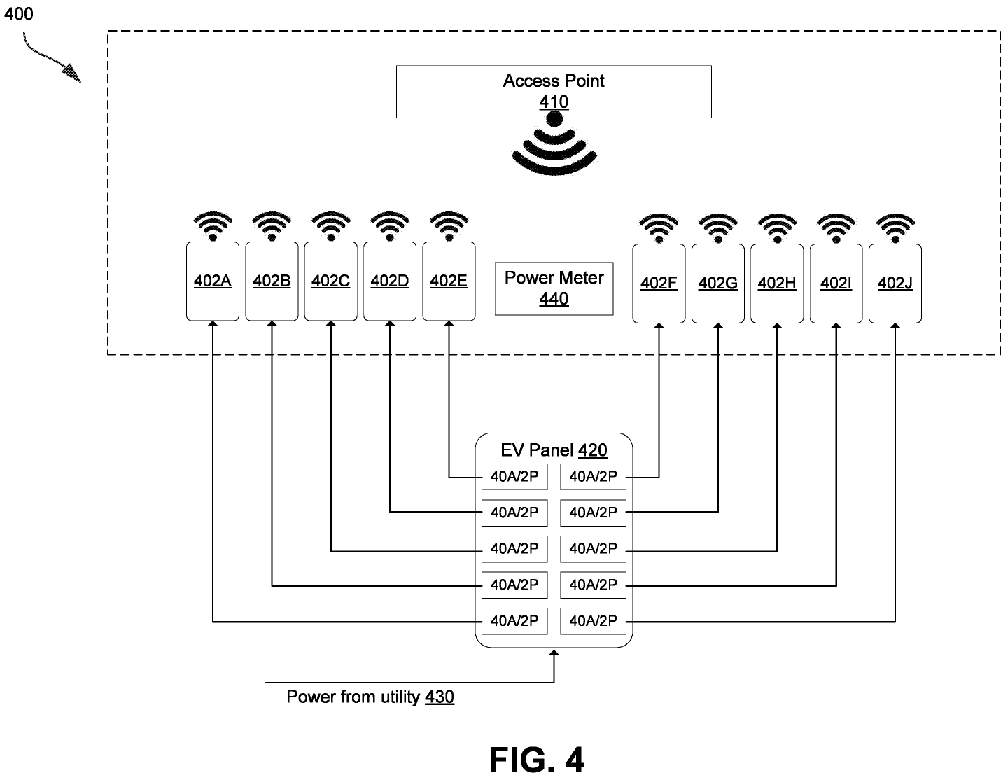

FIG. 4 illustrates an example wireless dynamic load management system 400. In the illustrative example of FIG. 4, EV panel 420 comprises 10 circuit breakers or overcurrent protective devices (OCPDs) (e.g., 40 Amp Two-Pole (40 A/2 p) circuit breaker) corresponding to 10 EVSEs 402A, 402B, . . . , 402J. EV panel 420 can receive power from utility 430, which can be distributed to a plurality of EVSEs 402.

As illustrated, wireless dynamic load management system 400 comprises an access point 410, which is configured to facilitate communication and control between various devices and components within wireless dynamic load management system 400 (e.g., a plurality of EVSEs 402A, 402B, . . . , 402J (collectively, a plurality of EVSEs 402), power meter 440, etc.). For example, access point 410 may provide a network connection for the plurality of EVSEs 402 to communicate with each other by establishing a wireless local area network (WLAN) or Wi-Fi network. As follows, one of the plurality of EVSEs 402, which may be designated as a load manager (e.g., load manager 210) can connect wirelessly with the rest of the plurality of EVSEs 402 and exchange data.

In some aspects, wireless dynamic load management system 400 allows wireless data transfer of the site load usage data from power meter 440 to access point 410, which may be shared with one or more EVSEs of the plurality of EVSEs 402 on a given site. As follows, as previously described, the LAN connection may allow the plurality of EVSEs 402 to be placed farther apart from each other in a large horizontal space or even among different building floors without the need to install extensive data cables between devices. In some examples, a load manager (e.g., load manager 210) can wirelessly control the power consumed by the plurality of EVSEs 402 via the wireless connection.

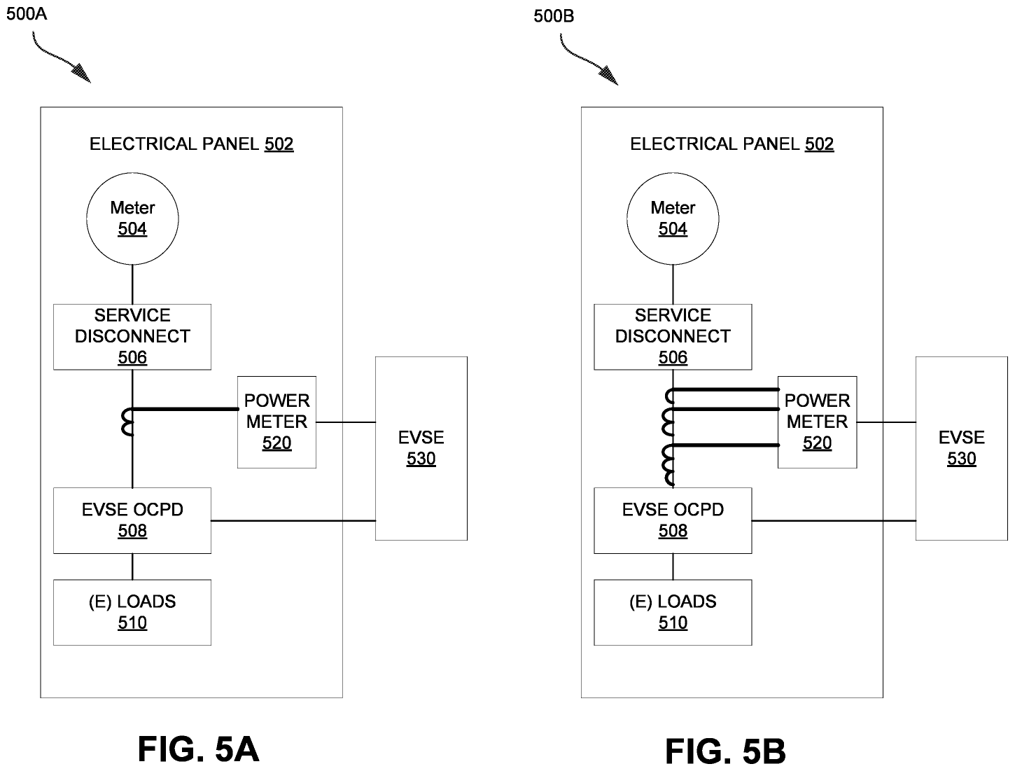

FIGS. 5A and 5B illustrate an example connection between an electrical panel, a power meter, and an EVSE. As previously described, power meter 520 can be mounted on electrical panel 502 and communicate with EVSE 530. In FIG. 5A, an example connection 500A depicts a single-phase application and an example connection 500B in FIG. 5B depicts a three-phase application. As previously described, electrical panel 502 can receive a main power supply, which may come from a utility grid or an on-site electrical generator (e.g., power from utility 430 as illustrated in FIG. 4). For example, the power supply can be connected to electrical panel 502 through a utility meter 504 and/or service disconnect 506 (e.g., a switch or a circuit breaker).

As shown, electrical panel 502 may comprise EVSE OCPD 508, which may be installed within electrical panel 502 and configured to protect connected devices from excessive current. The electrical panel may comprise (E) loads 510, which may be connected to electrical panel 502 and consume power such as any electrical devices or equipment.

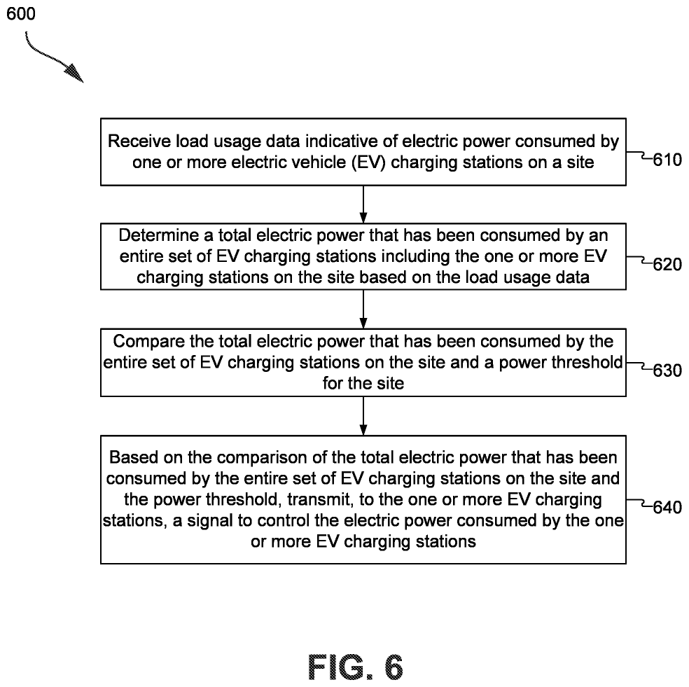

FIG. 6 is a flowchart illustrating an example process 600 for dynamically managing electric power for EV charging stations. Although the example process 600 depicts a particular sequence of operations, the sequence may be altered without departing from the scope of the present disclosure. For example, some of the operations depicted may be performed in parallel or in a different sequence that does not materially affect the function of process 600. In other examples, different components of an example device or system that implements process 600 may perform functions at substantially the same time or in a specific sequence.

At block 610, process 600 includes receiving load usage data indicative of electric power consumed by one or more EV charging stations on a site. Each of the one or more EV charging stations is simultaneously charging a respective EV. For example, load manager 210 can receive load usage data indicative of electric power consumed by one or more secondary EVSEs 204A-204N at site A that are simultaneously charging a respective EV (e.g., EV 150).

In some cases, the load usage data is collected by a power meter for the site. For example, the load usage data may be collected by power meter 220 for site A that can provide the amount of power consumption of secondary EVSEs 204A-204N at site A. As previously described, the power meter (e.g., power meter 220) can provide the information associated with the collective energy draw or collective load usage of the entire site (e.g., site A) and signal power control measure to load manager 210.

In some examples, the one or more EV charging stations are connected to a Local Area Network (LAN). For example, one or more EVSE 204A-204N at site A (or a plurality of EVSEs 402 as illustrated in FIG. 4) can be connected to a LAN so that load manager 210 can manage and control the loads collectively and wirelessly via Ethernet or Wi-Fi connection.

At block 620, process 600 includes determining a total electric power that has been consumed by an entire set of EV charging stations on the site based on the load usage data. For example, load manager 210 can calculate a total electric power consumed by EVSE 204A-204N at site A that are simultaneously charging EVs based on the load usage data.

At block 630, process 600 includes comparing the total electric power that has been consumed by the entire set of EV charging stations and a power threshold for the site. For example, load manager 210 can compare the calculated total electric power consumed by EVSE 204A-204N and a power threshold for site A (e.g., 95% of the maximum power capacity at site A).

At block 640, process 600 includes based on the comparison of the total electric power that has been consumed by the entire set of EV charging stations and the power threshold, transmitting, to the one or more EV charging stations, a signal to control the electric power consumed by the one or more EV charging stations. For example, based on the comparison between the total electric power consumed by EVSE 204A-204N and the power threshold (e.g., 95% of the maximum power capacity at site A), load manager 210 may transmit, to the respective EVSE 204A-204N, a signal to control the respective EVSE 204A-204N.

In some cases, the signal is transmitted to the one or more EV charging stations via a wireless connection. For example, load manager 210 may transmit the signal to EVSE 204A-204N via a wireless connection.

In some cases, the signal is transmitted to the one or more EV charging stations over cable. For example, load manager 210 may transmit the signal to EVSE 204A-204N via a wired cable.

In some examples, transmitting the signal to control the electric power consumed by the one or more EV charging stations can include determining that the total electric power that has been consumed by the entire set of EV charging stations exceeds the power threshold. For example, load manager 210 can determine the total electric power consumed by EVSE 204A-204N exceeds the power threshold (e.g., 95% of the maximum power capacity at site A).

In response to determining that the total electric power that has been consumed by the entire set of EV charging stations exceeds the power threshold, transmitting, to the one or more EV charging stations, the signal to reduce the electric power that is delivered to the respective EV. For example, in response to determining that the total electric power consumed by EVSE 204A-204N exceeds the power threshold (e.g., 95% of the maximum power capacity at site A), load manager 210 may transmit a signal, to EVSE 204A-204N, to reduce the electric power that is delivered to the respective EV that EVSE 204A-204N is charging.

In some aspects, the signal to reduce the electric power that is delivered to the respective EV includes the signal to reduce current by a predetermined increment. For example, load manager 210 can transmit a signal to reduce the electric power delivered to each of EVSE 204A-204N that is charging the respective EV by gradually reducing current by a pre-determined increment (e.g., 1 amp).

FIG. 7 illustrates an example configuration 700 of a neural network 708 that can be used to implement all or a portion of the systems and techniques described herein (e.g., neural network 708 can be used to implement load manager 210 as discussed above). The example configuration of neural network 708 is merely one illustrative example provided for clarity and explanation purposes. One of ordinary skill in the art will recognize that other configurations of a neural network are also possible and contemplated herein.

An input layer 720 can be configured to receive load usage data and/or data relating to EV charging station(s) on a site. Neural network 708 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 708 further includes an output layer 721 that provides an output resulting from the processing performed by the hidden layers 722a, 722b, through 722n.

Neural network 708 is a multi-layer neural network of interconnected nodes. Each node can represent a piece of information. Information associated with the nodes is shared among the different layers and each layer retains information as information is processed. In some cases, the neural network 708 can include a feed-forward network, in which case there are no feedback connections where outputs of the network are fed back into itself. In some cases, the neural network 708 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 708 are shown as having multiple output lines, a node can have a single output and all lines shown as being output from a node represent the same output value.

In some cases, each node or interconnection between nodes can have a weight that is a set of parameters derived from the training of the neural network 708. Once the neural network 708 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 708 to be adaptive to inputs and able to learn as more and more data is processed.

The neural network 708 is pre-trained to process the features from the data in the input layer 720 using the different hidden layers 722a, 722b, through 722n in order to provide the output through the output layer 721.

In some cases, the neural network 708 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 708 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 708 can perform a backward pass by determining which inputs (weights) most contributed to the loss of the network, and can adjust the weights so that the loss decreases and is eventually minimized.

The neural network 708 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 708 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

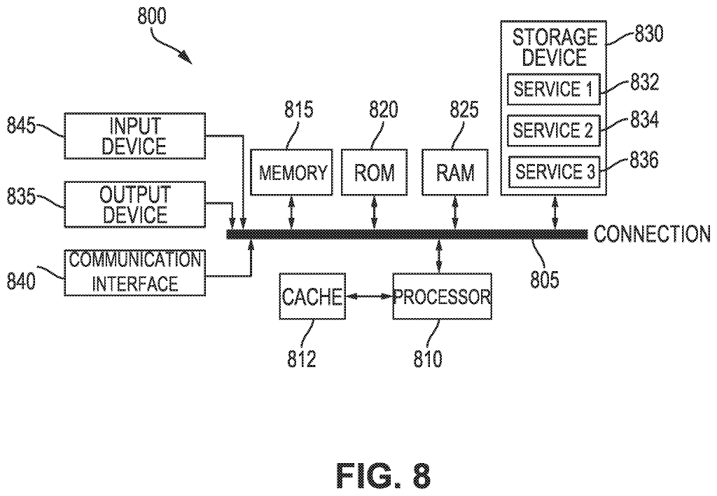

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communication interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A dynamic load management system comprising: a memory; and one or more processors coupled to the memory, the one or more processors being configured to: receive load usage data indicative of electric power consumed by one or more electric vehicle (EV) charging stations on a site, wherein each of the one or more EV charging stations is simultaneously charging a respective EV; determine a total electric power that has been consumed by an entire set of EV charging stations including the one or more EV charging stations on the site based on the load usage data; compare the total electric power that has been consumed by the entire set of EV charging stations on the site and a power threshold for the site; and based on the comparison of the total electric power that has been consumed by the entire set of EV charging stations on the site and the power threshold, transmit, to the one or more EV charging stations, a signal to control the electric power consumed by the one or more EV charging stations.

Aspect 2. The dynamic load management system of Aspect 1, wherein transmitting, to the one or more EV charging stations, the signal to control the electric power consumed by the one or more EV charging stations comprises: determining that the total electric power that has been consumed by the entire set of EV charging stations exceeds the power threshold; and in response to determining that the total electric power that has been consumed by the entire set of EV charging stations exceeds the power threshold, transmitting, to the one or more EV charging stations, the signal to reduce the electric power that is delivered to the respective EV.

Aspect 3. The dynamic load management system of Aspect 2, wherein the signal to reduce the electric power that is delivered to the respective EV includes the signal to reduce current by a predetermined increment.

Aspect 4. The dynamic load management system of any of Aspects 1 to 3, wherein the one or more EV charging stations are connected to a Local Area Network (LAN).

Aspect 5. The dynamic load management system of any of Aspects 1 to 4, wherein the signal is transmitted to the one or more EV charging stations via a wireless connection.

Aspect 6. The dynamic load management system of any of Aspects 1 to 5, wherein the signal is transmitted to the one or more EV charging stations over cable.

Aspect 7. The dynamic load management system of any of Aspects 1 to 6, wherein the load usage data is collected by a power meter for the site.

Aspect 8. A method comprising: receiving load usage data indicative of electric power consumed by one or more electric vehicle (EV) charging stations on a site, wherein each of the one or more EV charging stations is simultaneously charging a respective EV; determining a total electric power that has been consumed by an entire set of EV charging stations including the one or more EV charging stations on the site based on the load usage data; comparing the total electric power that has been consumed by the entire set of EV charging stations on the site and a power threshold for the site; and based on the comparison of the total electric power that has been consumed by the entire set of EV charging stations on the site and the power threshold, transmitting, to the one or more EV charging stations, a signal to control the electric power consumed by the one or more EV charging stations.

Aspect 9. The method of Aspect 8, wherein transmitting, to the one or more EV charging stations, the signal to control the electric power consumed by the one or more EV charging stations comprises: determining that the total electric power that has been consumed by the entire set of EV charging stations exceeds the power threshold; and in response to determining that the total electric power that has been consumed by the entire set of EV charging stations exceeds the power threshold, transmitting, to the one or more EV charging stations, the signal to reduce the electric power that is delivered to the respective EV.

Aspect 10. The method of Aspect 9, wherein the signal to reduce the electric power that is delivered to the respective EV includes the signal to reduce current by a predetermined increment.

Aspect 11. The method of any of Aspects 8 to 10, wherein the one or more EV charging stations are connected to a Local Area Network (LAN).

Aspect 12. The method of any of Aspects 8 to 11, wherein the signal is transmitted to the one or more EV charging stations via a wireless connection.

Aspect 13. The method of any of Aspects 8 to 12, wherein the signal is transmitted to the one or more EV charging stations over cable.

Aspect 14. The method of any of Aspects 8 to 13, wherein the load usage data is collected by a power meter for the site.

Aspect 15. A non-transitory computer-readable medium having stored thereon instructions which, when executed by one or more processors, cause the one or more processors to: receive load usage data indicative of electric power consumed by one or more electric vehicle (EV) charging stations on a site, wherein each of the one or more EV charging stations is simultaneously charging a respective EV; determine a total electric power that has been consumed by an entire set of EV charging stations including the one or more EV charging stations on the site based on the load usage data; compare the total electric power that has been consumed by the entire set of EV charging stations on the site and a power threshold for the site; and based on the comparison of the total electric power that has been consumed by the entire set of EV charging stations on the site and the power threshold, transmit, to the one or more EV charging stations, a signal to control the electric power consumed by the one or more EV charging stations.

Aspect 16. The non-transitory computer-readable medium of Aspect 15, wherein transmitting, to the one or more EV charging stations, the signal to control the electric power consumed by the one or more EV charging stations comprises: determining that the total electric power that has been consumed by the entire set of EV charging stations exceeds the power threshold; and in response to determining that the total electric power that has been consumed by the entire set of EV charging stations exceeds the power threshold, transmitting, to the one or more EV charging stations, the signal to reduce the electric power that is delivered to the respective EV.

Aspect 17. The non-transitory computer-readable medium of Aspect 16, wherein the signal to reduce the electric power that is delivered to the respective EV includes the signal to reduce current by a predetermined increment.

Aspect 18. The non-transitory computer-readable medium of any of Aspects 15 to 17, wherein the one or more EV charging stations are connected to a Local Area Network (LAN).

Aspect 19. The non-transitory computer-readable medium of any of Aspects 15 to 18, wherein the signal is transmitted to the one or more EV charging stations via a wireless connection.

Aspect 20. The non-transitory computer-readable medium of any of Aspects 15 to 19, wherein the signal is transmitted to the one or more EV charging stations over cable.

What is claimed is:

1. A dynamic load management system comprising:
a memory; and
one or more processors coupled to the memory, the one or more processors being configured to:
receive load usage data indicative of electric power consumed by one or more electric vehicle (EV) charging stations on a site, wherein each of the one or more EV charging stations is simultaneously charging a respective EV;
determine a total electric power that has been consumed by an entire set of EV charging stations including the one or more EV charging stations on the site based on the load usage data;
compare the total electric power that has been consumed by the entire set of EV charging stations on the site and a power threshold for the site; and
based on the comparison of the total electric power that has been consumed by the entire set of EV charging stations on the site and the power threshold, transmit, to the one or more EV charging stations, a signal to control the electric power consumed by the one or more EV charging stations.

2. The dynamic load management system of claim 1, wherein transmitting, to the one or more EV charging stations, the signal to control the electric power consumed by the one or more EV charging stations comprises:
determining that the total electric power that has been consumed by the entire set of EV charging stations exceeds the power threshold; and
in response to determining that the total electric power that has been consumed by the entire set of EV charging stations exceeds the power threshold, transmitting, to the one or more EV charging stations, the signal to reduce the electric power that is delivered to the respective EV.

3. The dynamic load management system of claim 2, wherein the signal to reduce the electric power that is delivered to the respective EV includes the signal to reduce current by a predetermined increment.

4. The dynamic load management system of claim 1, wherein the one or more EV charging stations are connected to a Local Area Network (LAN).

5. The dynamic load management system of claim 1, wherein the signal is transmitted to the one or more EV charging stations via a wireless connection.

6. The dynamic load management system of claim 1, wherein the signal is transmitted to the one or more EV charging stations over cable.

7. The dynamic load management system of claim 1, wherein the load usage data is collected by a power meter for the site.

8. A method comprising:
receiving load usage data indicative of electric power consumed by one or more electric vehicle (EV) charging stations on a site, wherein each of the one or more EV charging stations is simultaneously charging a respective EV;
determining a total electric power that has been consumed by an entire set of EV charging stations including the one or more EV charging stations on the site based on the load usage data;
comparing the total electric power that has been consumed by the entire set of EV charging stations on the site and a power threshold for the site; and
based on the comparison of the total electric power that has been consumed by the entire set of EV charging stations on the site and the power threshold, transmitting, to the one or more EV charging stations, a signal to control the electric power consumed by the one or more EV charging stations.

9. The method of claim 8, wherein transmitting, to the one or more EV charging stations, the signal to control the electric power consumed by the one or more EV charging stations comprises:
determining that the total electric power that has been consumed by the entire set of EV charging stations exceeds the power threshold; and
in response to determining that the total electric power that has been consumed by the entire set of EV charging stations exceeds the power threshold, transmitting, to the one or more EV charging stations, the signal to reduce the electric power that is delivered to the respective EV.

10. The method of claim 9, wherein the signal to reduce the electric power that is delivered to the respective EV includes the signal to reduce current by a predetermined increment.

11. The method of claim 8, wherein the one or more EV charging stations are connected to a Local Area Network (LAN).

12. The method of claim 8, wherein the signal is transmitted to the one or more EV charging stations via a wireless connection.

13. The method of claim 8, wherein the signal is transmitted to the one or more EV charging stations over cable.

14. The method of claim 8, wherein the load usage data is collected by a power meter for the site.

15. A non-transitory computer-readable medium having stored thereon instructions which, when executed by one or more processors, cause the one or more processors to:
receive load usage data indicative of electric power consumed by one or more electric vehicle (EV) charging stations on a site, wherein each of the one or more EV charging stations is simultaneously charging a respective EV;
determine a total electric power that has been consumed by an entire set of EV charging stations including the one or more EV charging stations on the site based on the load usage data;
compare the total electric power that has been consumed by the entire set of EV charging stations on the site and a power threshold for the site; and
based on the comparison of the total electric power that has been consumed by the entire set of EV charging stations on the site and the power threshold, transmit, to the one or more EV charging stations, a signal to control the electric power consumed by the one or more EV charging stations.

16. The non-transitory computer-readable medium of claim 15, wherein transmitting, to the one or more EV charging stations, the signal to control the electric power consumed by the one or more EV charging stations comprises:
determining that the total electric power that has been consumed by the entire set of EV charging stations exceeds the power threshold; and
in response to determining that the total electric power that has been consumed by the entire set of EV charging stations exceeds the power threshold, transmitting, to the one or more EV charging stations, the signal to reduce the electric power that is delivered to the respective EV.

17. The non-transitory computer-readable medium of claim 16, wherein the signal to reduce the electric power that is delivered to the respective EV includes the signal to reduce current by a predetermined increment.

18. The non-transitory computer-readable medium of claim 15, wherein the one or more EV charging stations are connected to a Local Area Network (LAN).

19. The non-transitory computer-readable medium of claim 15, wherein the signal is transmitted to the one or more EV charging stations via a wireless connection.

20. The non-transitory computer-readable medium of claim 15, wherein the signal is transmitted to the one or more EV charging stations over cable.
